(19) United States
(12) Patent Application Publication
(10) Pub. No.: US 2014/0255701 A1
(43) Pub. Date: Sep. 11, 2014

(54) DIAMOND-LIKE CARBON FILM AND METHOD FOR FABRICATING THE SAME

(71) Applicant: National Tsing Hua University, Hsinchu (TW)

(72) Inventors: Chi-Young Lee, Hsinchu (TW); I-Nan Lin, Hsinchu (TW); Chien-Fu Chen, Hsinchu (TW)

(73) Assignee: National Tsing Hua University, Hsinchu (TW)

(21) Appl. No.: 13/970,189

(22) Filed: Aug. 19, 2013

(30) Foreign Application Priority Data
Mar. 8, 2013 (TW) 102108297

(51) Int. Cl. H01B 1/04; H01B 13/00

(52) U.S. Cl. CPC H01B 1/04; H01B 13/00
USPC 428/408; 427/122; 427/575; 252/502; 427/560

(57) ABSTRACT

A diamond-like carbon film for improving an efficiency of a field emitting element is disclosed in the present invention. The abovementioned diamond-like carbon film is deposited on a substrate and uses a mixture of graphite fiber and diamond powder as its nucleation layer. Furthermore, a method for fabricating the abovementioned diamond-like carbon film is also disclosed in the present invention and at least comprises the following steps. First, a substrate and a mixing solution composed of graphite fiber and diamond powder are provided. And then, a nucleation layer is formed on the substrate by utilizing the mixing solution. A diamond-like carbon film is finally deposited on the substrate by utilizing the nucleation layer.

### CROSS-REFERENCE TO RELATED APPLICATIONS

This Non-provisional application claims priority under 35 U.S.C. §119(a) on Patent Application No(s). 102108297 filed in Taiwan, Republic of China, Mar. 8, 2013, the entire contents of which are hereby incorporated by reference.

### FIELD OF THE INVENTION

This invention relates to a diamond-like carbon film, especially relates to a diamond-like carbon film fabricated by coating mixed graphite fibers and diamond powders on a substrate as its nucleation layer and a method of fabricating thereof.

### BACKGROUND OF THE INVENTION

Electron field emission theory was developed by R. H. Fowler and L. W. Nordheim in 1928. The principle is that the potential energy of the electrons at the cathode surface and the vacuum zone will be reduced when a high voltage is applied between two conductors, and further, the thickness of potential barrier also reduced at the same time. When the voltage is high and the barrier thickness (Dx) is small, electronics can direct tunnel barrier into the vacuum so that there are a plurality of electrons emitted from the cathode surface without crossing the potential barrier height DE. The abovementioned is the basic mechanism of the field emission.

In recent years, the field emission properties of materials have been developed. The conventional hot-electron guns almost can be replaced with the cold cathode of the field emission for all the application of the electron beam emission devices. Therefore, displays, electron microscopy and sensors, etc., are covered in application areas of the field emission materials. Study on the field emission materials is especially the most urgently needed device technology of the field emission production now.

In addition to the need of the field emission element with a lower turn-on field and high current density, life, heat-resisting and cost are also needed to be considered. Therefore, metal, silicon and metal silicides were ever used as one of candidates for the field emission materials. In detail, the research of the field emission material is first concentrated in metal material with high melting point, such as W, Mo, Re and Ta. And further, Tungsten metal (W) is the first one among them to be applied, but it has highly requirement for vacuum degree as the field emission cathode materials. Moreover, the silicon material is also included in the scope of the study of the field emission materials due to the rise of the semiconductor industry. If pure silicon materials are used to form needle-like structures and small grid intervals, good field emission efficiency can be obtained. However, the thermal stability, uniformity and efficiency of the silicon-based emission material still need to be improved. As to the carbon-based materials, it, such as carbon nanotube, diamond-like carbon and nanodiamond, also becomes a popular field emission material due to its electron affinity. Although the carbon nanotube has lower turn-on field, its manufacture is hard to control and it is unstable.

But on the contrary the diamond film got weight within the study of the field emission cathode material due to its unique physical and chemical properties. Because the diamond film has lower turn-on field, wear resistance and good heat radiation, its performance and life can fit in with the abovementioned needs. However, the field emission property of the diamond film still cannot satisfy the requests of the product, and there is a large space for it to be improved.

### SUMMARY OF THE INVENTION

According to the abovementioned disadvantages of the prior art, the present invention adds nano-graphite fibers and nano-diamond powders, which have been mixed uniformly, in the nucleation process of the diamond-like carbon film. That is, the mixed graphite fibers and diamond powders are used as a nucleation layer of the film for improving an efficiency of the film and decreasing the turn-on field of the film to let it less than 5V/μm. Therefore, the business value of a field emitting element using thereof will be greatly raised.

Thus, the present invention provides a diamond-like carbon film for improving an efficiency of a field emitting element. The abovementioned diamond-like carbon film is formed on a substrate and comprises a mixture of a graphite fiber and a diamond powder as its nucleation layer.

Preferably, the diamond powder and the graphite fiber are mixed with a mixed proportion of 1:6.

Preferably, the diamond powder and the graphite fiber are mixed with a mixed proportion of 2:5.

Preferably, the diamond-like carbon film disclosed in the present invention has a turn-on field less than 5V/μm.

Preferably, the nucleation layer comprises a first portion and a second portion covered thereon. Furthermore, the first portion comprises the graphite fiber and the second portion comprises the diamond power and the graphite fiber. Preferably, the graphite fiber of the first portion is meshed and dispersed uniformly on the substrate.

Preferably, the graphite fiber and the diamond power are both nanomaterials.

Preferably, the nucleation layer is coated on the substrate by a spin coating process.

Preferably, the substrate is a silicon substrate.

The present invention further provides a method of fabricating a diamond-like carbon film, and the method at least comprises the following steps. First, a substrate and a mixing solution composed of a graphite fiber and a diamond powder are provided. A nucleation layer on the substrate by utilizing the mixing solution is then formed. Finally, the diamond-like carbon film on the substrate is formed by utilizing the nucleation layer.

Preferably, the step of providing the mixing solution composed of the graphite fiber and the diamond powder further comprises the following steps. First, the diamond powder and the graphite fiber are mixed as a solute. And then, an alcohol is added into the solute as a solvent to form the mixing solution.

Preferably, the diamond powder and the graphite fiber are mixed with a mixed proportion of 1:6.

Preferably, the method further comprises the following step before the step of mixing the diamond powder and the graphite fiber as the solute: acid washing the diamond powder.

Preferably, the solute further comprises ethyl cellulose, and the diamond powder, the graphite fiber and the ethyl cellulose are mixed with a mixed proportion of 1:6:7. Preferably, the solute of the mixing solution has a total concentration of 0.045 g/ml.

Preferably, the step of adding the alcohol into the solute as the solvent to form the mixing solution is performed inside a thick liquid mixer with an ultrasonic process.

Preferably, the step of forming the nucleation layer on the substrate by utilizing the mixing solution is performed by a spin coating process. Preferably, the spin coating process has a rotational speed of 4500 rpm for 30 seconds.

Preferably, the method further comprises a step after the step of forming the nucleation layer on the substrate by utilizing the mixing solution: annealing the substrate.

Preferably, the step of forming the diamond-like carbon film on the substrate by utilizing the nucleation layer is performed by microwave plasma enhanced chemical vapor deposition process. Preferably, the gas used in the microwave plasma enhanced chemical vapor deposition process is methane, hydrogen and argon. Preferably, the methane, the hydrogen and the argon are mixed with a mixed proportion of 1:50:49.

Preferably, the method further comprises the following steps before the step of providing the substrate further comprising the following steps. First, the substrate is immersed in acetone, and an ultrasonic process is then performed on the surface of the substrate.

Preferably, the diamond-like carbon film fabricated according to the abovementioned method has a turn-on field less than 5V/μm.

The features and advantages of the present invention will be understood and illustrated in the following specification and FIGS. 1˜6.

### BRIEF DESCRIPTION OF THE DRAWINGS

FIG. 1 is diagram showing the structure of the diamond-like carbon film according to an embodiment of the present invention;

FIG. 2 is flow chart showing a method of fabricating the diamond-like carbon film according to the embodiment of the present invention;

FIG. 3A is diagram showing SEM images of spin coating the graphite fiber and the diamond powder with different mixed proportions according to a preferred embodiment of the present invention;

FIG. 3B is diagram showing SEM images of the diamond-like carbon film formed after spin coating the graphite fiber and the diamond powder with different mixed proportions according to a preferred embodiment of the present invention;

FIG. 4 is diagram showing SEM images of the diamond-like carbon film formed after spin coating the graphite fiber and the diamond powder with different concentrations of the mixing solution according to a preferred embodiment of the present invention;

FIG. 5A is diagram showing SEM images of electrophoresis-deposited diamond layer and different carbon materials deposition;

FIG. 5B is diagram showing SEM images of electrophoresis-deposited and different carbon embedded diamond film; and

FIG. 6 is diagram showing surface roughness analysis of AFM measured from the diamond-like carbon film fabricated by different seeding process and embedded with the graphite fibers.

### DETAILED DESCRIPTION OF THE INVENTION

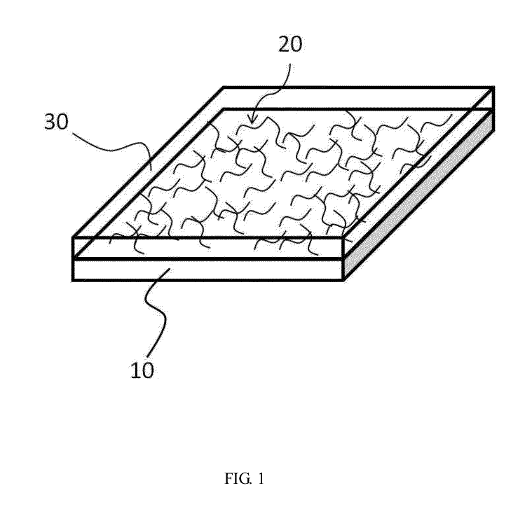

First, please refer to FIG. 1, FIG. 11S diagram showing the structure of the diamond-like carbon film according to an embodiment of the present invention. As shown in the figure, the diamond-like carbon film 30 provided in the present invention is formed on a substrate 10, and further, the diamond-like carbon film 30 uses mixed graphite fibers and diamond powders as its nucleation layer 20. That is, the nucleation layer 20 is formed on the substrate 10 first during the nucleation process of the diamond-like carbon film 30, and the nucleation layer 20 comprises the graphite fibers and the diamond powders. Preferably, the substrate 10 is a silicon substrate.

Preferably, the diamond powders and the graphite fibers, which are used to form the nucleation layer 20, are mixed with a mixed proportion of 1:6. Moreover, the abovementioned proportion also can be 2:5 in another preferred embodiment, and basically the content of the diamond powders will not exceed two seventh of the whole mixture. The present invention is not limited to any of the embodiments mentioned above. Preferably, the diamond-like carbon film 30 provided in the present invention has a turn-on field less than 5V/μm.

Although it is not shown in the figure, the nucleation layer 20 comprises a first portion and a second portion covered on the first portion. The first portion covers the substrate 10 and is composed of the graphite fibers, and the second portion comprises the diamond powders and the graphite fibers. When the diamond powders and the graphite fibers are mixed and further coated on the substrate 10 by a spin coating process, the graphite fibers, which are contained within the first portion, are meshed and dispersed uniformly on the substrate 10 as shown in the figure. As to the spin coating process and the abovementioned structure will be clearly described in the following specification and SEM micrographs.

Preferably, the graphite fibers used in the present invention are nano-graphite fibers, and the diamond powders used in the present invention are also nano-diamond powders.

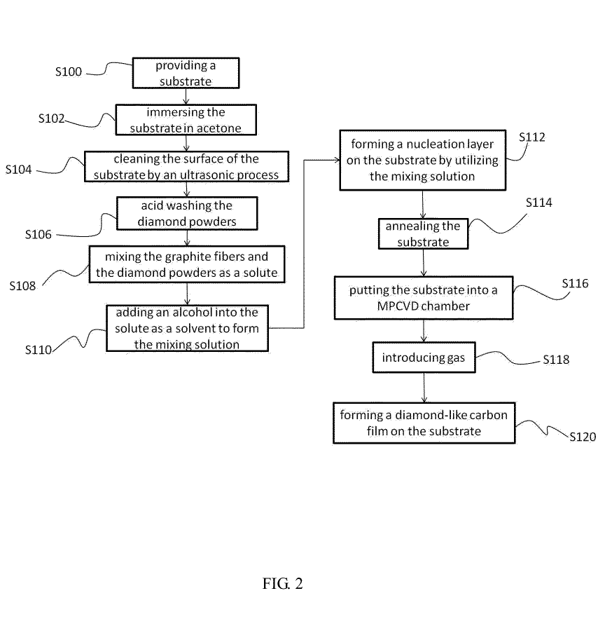

Please refer to FIG. 2, FIG. 2 is flow chart showing a method of fabricating the diamond-like carbon film according to the embodiment of the present invention. First, a substrate is provided as shown in step S100, and the substrate is then immersed in acetone as shown in step S102. In step S104, the surface of the substrate will be ultrasonically cleaned. Preferably, the substrate is silicon substrate, but the present invention is not limited thereto.

Before mixing the diamond powders and the graphite fibers with a proportion as shown in step S108, step S106 is performed to acid washing the diamond powders. Preferably, the step S106 is performed with sulfuric acid and nitric acid by a proportion of 1:3 for 5 minutes. However, the present invention is not limited thereto. After mixing the diamond powders and the graphite fibers as a solute in the step S108, an alcohol is added into the solute as a solvent to form a mixing solution as shown in step S110.

Preferably, the solute further comprises ethyl cellulose. The ethyl cellulose is used as an adhesive and a film former, and it will disappear during the following annealing process. Preferably, the step S110 is performed inside a thick liquid mixer with an ultrasonic process to let the graphite fibers and the ethyl cellulose disperse in the solvent.

And then, a spin coating process is performed to the substrate by the mixing solution, which is composed of the diamond powders, the graphite fibers and the ethyl cellulose, as shown in step S112. Preferably, the spin coating process has a rotational speed of 4500 rpm for 30 seconds to let the graphite fibers be meshed and disperse uniformly on the substrate as shown in FIG. 1. After coating, the substrate is put into a grease removal device to be dealt with an annealing process as shown in step S114. Preferably, the annealing process has three stages. That is, the temperature is raised to 323K for 10 minutes first and further raised to 400K for 2 hours. Finally, the temperature will be maintained at 573K for one hour. Thus, the ethyl cellulose will depart from the substrate due to heat, and the graphite fibers, which are meshed and dispersed uniformly on the substrate, and the diamond powders, which are dispersed along the meshed graphite fibers, will be remained thereon to form the nucleation layer of the following thin film process.

As shown in step S116, the substrate, which has the nucleation layer formed thereon, is put into a chamber of a chemical vapor deposition to process the following thin film process of the diamond-like carbon film. Preferably, the above chamber is a chamber of a microwave plasma enhanced chemical vapor deposition process. That is, the thin film process used in the present invention is microwave plasma enhanced chemical vapor deposition process. Moreover, a mixing gas is introduced during the microwave plasma enhanced chemical vapor deposition process as shown in step S118, and the diamond-like carbon film is finally formed on the substrate as shown in step S120.

Preferably, the mixing gas used in the step S118 is composed of methane, hydrogen and argon, and they are mixed with a mixed proportion of 1:50:49. When the pressure of the chamber is raised to 2 torr by the introduced gas, a microwave source and a water cooling system are switched on. The power of the microwave source is then adjusted to 600 W, and the pressure of the chamber is started to be raised after the plasma therein is stable. The pressure is raised gradually and finally fixed at 80 torr. Furthermore, the plasma watt will follow each raise of the pressure to be raised with a value of 200 W and is finally fixed at 1300 W for one hour. However, the abovementioned references are all used as a preferred embodiment, the present invention is not limited thereto.

It is noted that the preferred mixed proportion between the diamond powders and the graphite fibers is 1:6, and the next best is 2:5. As to the mixed proportion between the diamond powders, the graphite fibers and the ethyl cellulose, it is 1:6:7 preferably. Moreover, the solute of the mixing solution has a total concentration of 0.045 g/ml, but the present invention is not limited thereto.

The abovementioned mixed proportion and the total concentration of the solute are the preferred embodiment. That is, the present invention provides the preferred proportion between the diamond powders and the graphite fibers, the concentration, seeding and nucleation process to emphasize that the field emission properties of the diamond-like carbon film, which is fabricated by using the diamond powders and the graphite fibers as the nucleation layer, can be raised. More details will be described as follows.

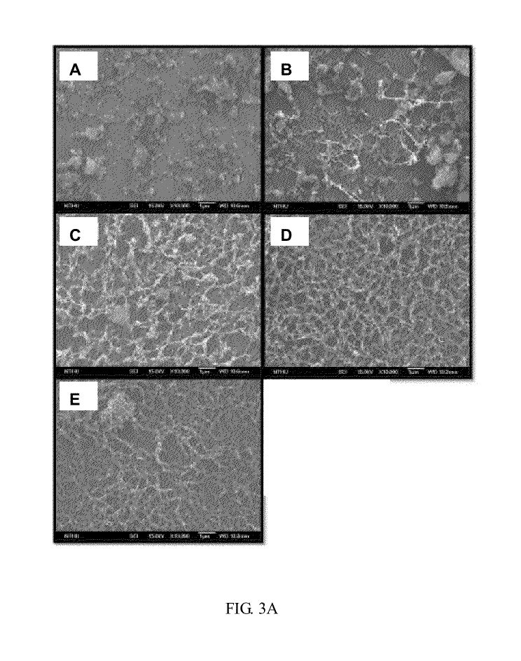

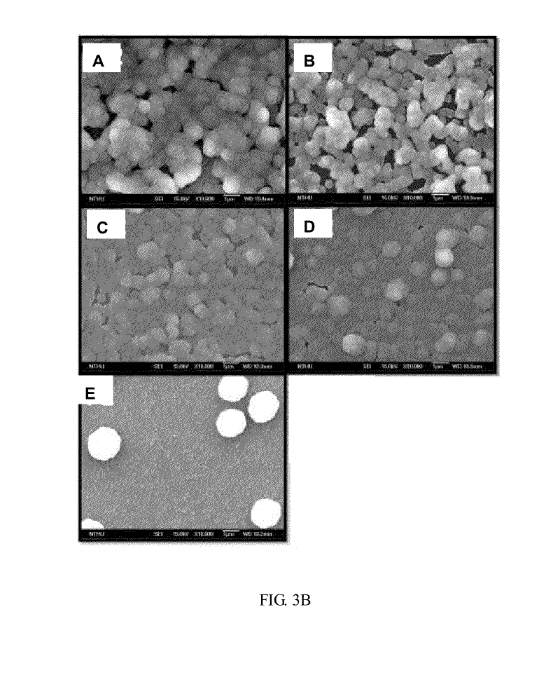

Please refer to FIGS. 3A˜3B, FIG. 3A is diagram showing SEM images of spin coating the graphite fiber and the diamond powder with different mixed proportions according to a preferred embodiment of the present invention and FIG. 3B is diagram showing SEM images of the diamond-like carbon film formed after spin coating the graphite fiber and the diamond powder with different mixed proportions according to a preferred embodiment of the present invention. First, two carbon materials, such as the diamond powders and the graphite fibers, are mixed with five different proportions as follows: 7:0 (A), 6:1(B), 3.5:3.5(C), 1:6(D) and 0:7(E). The above five mixing solutions composed of the diamond powders and the graphite fibers with different proportions are coated on the substrate and shown in FIG. 3A. As shown in FIG. 3AA, it is clearly that the diamond powders, which are not mixed with the graphite fibers, has poor uniformity after coating and will aggregate easily to further lower the uniformity of the film. After adding few graphite fibers as shown in FIG. 3AB, the diamond powders will disperse along the graphite fibers. Most of the diamond powders surround the graphite fibers so that the dispersion of the diamond powders will be improved and better than the previous one, which is coated by pure diamond powders and shown in FIG. 3AA. When the proportion between the diamond powders and the graphite fibers is 1:1 as shown in FIG. 3AC, the increase of the graphite fibers will make the fibers show a meshed and uniform distribution. Thus, the diamond powders, which attach to the graphite fibers, will disperse along the meshed distribution of the graphite fibers. And then, the density of the meshed graphite fibers will be obviously raised when the proportion of the graphite fibers is raised. Now, the aggregated diamond powders are almost gone and there is only few diamond powders dispersed between the meshed graphite fibers. However, it is noted that the graphite fibers will aggregate when the solution only contains the graphite fibers so that the density of the meshed graphite fibers will decrease as shown in FIG. 3AE.

The abovementioned five samples are then processed by the microwave plasma enhanced chemical vapor deposition process as shown in the steps S116˜S120 to deposit a diamond film. It is clearly that the density and the uniformity of the film are directly related to the nucleation layer. As shown in FIG. 3BA, the film fabricated from the sample without adding the graphite fibers has a quite poor uniformity, and its surface roughness is quite high. Moreover, the grains do not have uniform sizes. For example, the larger grain will be obtained when the diamond powders aggregated before and the smaller grains are formed from the portion having the dispersed diamond powders. As shown in FIG. 3BB, the diamond powders will become smaller as the decrease of the aggregation after adding few graphite powders. Although the film cannot wholly cover the substrate, its uniformity has been improved. As shown in FIG. 3BC, the density of the diamond film will be raised as the increase of the density of the meshed graphite fibers when the proportion of the graphite fibers are continuously raised. As shown in FIG. 3BD, the uniformity of the film is preferred when the proportion between the diamond powders and the graphite fibers. At last the sample, which is only coated by the graphite fibers, only grows few diamond grains as shown in FIG. 3BE due to its lower nucleation efficiency.

In view of the field emission properties, the preferred mixed proportion between the diamond powers and the graphite fibers is 1:6, and the diamond-like carbon film fabricated according to this proportion can be turned on at a low field as 4.4V/μm. Moreover, the diamond-like carbon film has a current density of 0.06 mA/cm² at 7V/μm applied field, that is, the diamond-like carbon film provided in the present invention is full of business value.

As to other proportions, the turn-on fields are 5.7V/μm and 6.9V/μm when the mixed proportions between the diamond powders and the graphite fibers are 3.5:3.5 and 6:1, separately. That is to say, they all have nice field emission properties except for the sample E (9.1V/μm), which is not mixed with the diamond powders, and the sample A (20.0V/μm), which is not mixed with the graphite fibers. However, the sample D, which is composed of the diamond powders and the graphite fibers mixed with a proportion of 1:6, has the best field emission property.

TABLE 1
field emission properties and resistances of the diamond-like
carbon film grown after spin coating the diamond powders
and the graphite fibers with different proportions

| | A | B | C | D | E |
|---|---|---|---|---|---|
| turn-on field | 20.0 | 6.9 | 5.7 | 4.4 | 9.1 |
| (V/μm) | | | | | |
| current density | <<0.001 | 0.001 | 0.004 | 0.06 | <<0.001 |
| At 7 V/μm | | | | | |
| (mA/cm²) | | | | | |
| Resistance | 16.8 | 0.64 | 0.37 | 0.23 | 0.19 |
| (Ω) | | | | | |

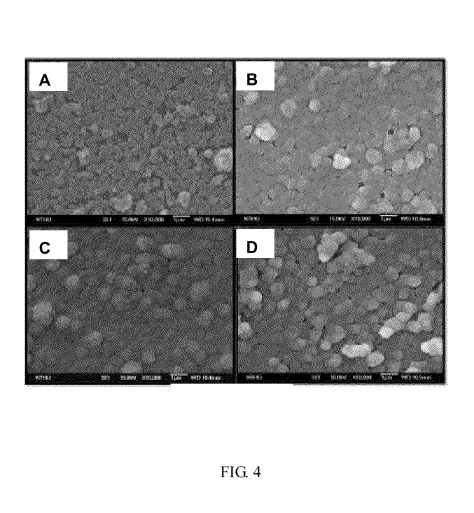

Please refer to FIG. 4, FIG. 4 is diagram showing SEM images of the diamond-like carbon film formed after spin coating the graphite fiber and the diamond powder with different concentrations of the mixing solution according to a preferred embodiment of the present invention. In view of the preferred mixed proportion of 1:6 between the diamond powders and graphite fibers, the present invention further processes the following experiments with different total concentration of the solute: 0.025 g/ml (A), 0.035 g/ml (B), 0.045 g/ml (C) and 0.055 g/ml (D). Basically, the amount of the material coated on the substrate increases as the concentration increases. As shown in FIG. 4A, the film coverage of the sample with the thinnest concentration is lower, and some portions of the silicon substrate are exposed. It is mainly due to the lower density of the diamond powders in the nucleation process, thus the film cannot completely cover the substrate. And then, a more uniform film will be obtained when the concentration is raised to 0.045 g/ml as shown in FIG. 4C. However, too many graphite fibers and diamond powders will result in aggregation as the concentration increases to 0.055 g/ml, thus the film becomes non-uniform as shown in FIG. 4D. Please refer to Table 2, it is clearly that the sample C, which has the uniform and fine film thereon, has the lowest turn-on field of 4.4 V/μm. The sample A, which has the thinnest concentration, has the highest turn-on field of 9.0 V/μm, and the turn-on field of the sample D with the thickest concentration is slightly raised to 5.6 V/μm. That is, the diamond-like carbon film has the best field emission property when the total concentration of the solution in the mixing solution is 0.045 g/ml.

TABLE 2
field emission properties and resistances of the diamond-like
carbon film grown after spin coating the diamond powders
and the graphite fibers with different concentration of the
mixing solution

| | A | B | C | D |
|---|---|---|---|---|
| turn-on field | 9.0 | 6.7 | 4.4 | 5.6 |
| (V/μm) | | | | |
| current density | <<0.001 | 0.002 | 0.06 | 0.004 |
| At 7 V/μm | | | | |
| (mA/cm²) | | | | |
| Resistance | 0.45 | 0.27 | 0.23 | 0.23 |
| (Ω) | | | | |

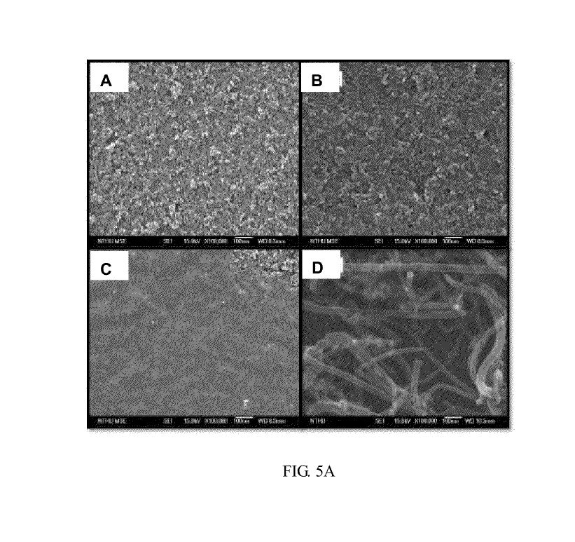

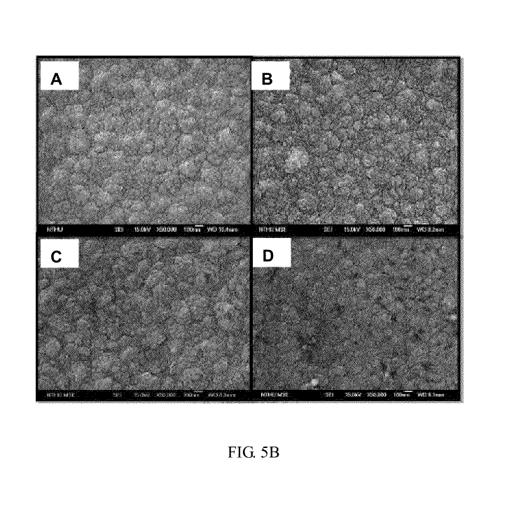

Please refer to FIGS. 5A˜5B, FIG. 5A is diagram showing SEM images of electrophoresis-deposited diamond layer and different carbon materials deposition, and FIG. 5B is diagram showing SEM images of electrophoresis-deposited and different carbon embedded diamond film.

First, a layer of diamond grains (A) is deposited on the substrate by electrophoresis. And then, the experiment is further divided into three parts: depositing the amorphous carbon after electrophoresis (B), spin coating graphene after electrophoresis (C) and spin coating graphite fibers after electrophoresis (D). As shown in FIG. 5AA, it is clearly that the coverage of the diamond grains is high and the deposition is uniform. Moreover, the graphite fiber are meshed as shown in FIG. 5AD for further helping the growth of the nano-diamond film. As shown in FIG. 5AC, the spin-coated graphene uniformly covers the electrophoresis-deposited diamond layer, and the growth of the amorphous carbon layer will let the surface of the sample change as shown in FIG. 5AB.

Because the sample B is fabricated by depositing the amorphous carbon layer with a thickness of 100 nm on the diamond layer, the growth of the diamond grains is initially blocked till the surface amorphous carbon is eroded by hydrogen to expose the diamond layer. Therefore, the grains of the sample B are smaller than others as shown in FIG. 5BB. Moreover, the diamond grains of the sample D are also smaller than others as shown in FIG. 5BD because the surface meshed graphite fiber is thicker and there are some impurities remained from the graphite fibers.

Please refer to the field emission properties as listed in Table 3, the turn-on fields of the abovementioned three carbon embedded nanocrystalline diamond film are obviously reduced, wherein the sample D is the best one and has the turn-on field of 6.2 V/μm. The sample C also has a good performance with the turn-on field of 6.5 V/μm. Although the figures and tables do not describe in details, the conductivity of each sample can be further measured by a four-point probe. Accordingly, the conductivities of the sample D and the sample C are obviously raised and that of the sample B is not obvious. Therefore, it can be pointed out that the variation of the conductivity is also a main reason for affecting the field emission property.

TABLE 3
field emission properties and resistances of the diamond-like
carbon film fabricated by electrophoresis and
embedded with different carbon materials

| | A | B | C | D |
|---|---|---|---|---|
| turn-on field | 28.5 | 9.5 | 6.5 | 6.2 |
| (V/μm) | | | | |
| current density | <0.001 | <0.001 | 0.01 | 0.13 |
| At 10 V/μm | | | | |
| (mA/cm²) | | | | |
| Resistance | 35.0 | 13.7 | 1.1 | 0.4 |
| (Ω) | | | | |

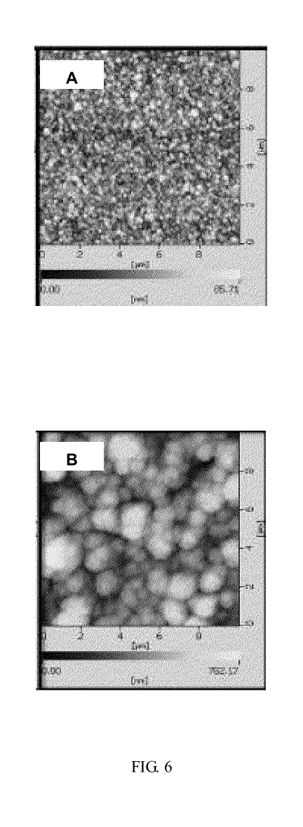

Please refer to FIGS. 6A˜6B, the figures show the surface roughness analysis of the diamond-like carbon film fabricated by embedding with the graphite fibers and different seeding process, and the analysis is performed by an atomic force microscopy (hereafter “AFM”). FIG. 6A shows AFM image of the diamond film, which is grown after depositing the diamond grains by electrophoresis and further spin coating the nano-graphite fibers thereon (it is equal to FIG. 5BA), and FIG. 6B shows AFM image of the diamond film, which is grown after spin coating the mixed nano-diamond powders and nano-graphite fibers with a proportion of 1:6 (that is the diamond-like carbon film and the method of fabricating the same disclosed in the present invention). As shown in the figures, the surface roughness of the sample A is only tenth of that of the sample B. The concentrative effect of the electric charges will happen easier and the local field will be enhanced when the surface is rougher. Thus, the electrons of the sample, which is fabricated by using the spin coating process in its nucleation process, can tunnel at a lower applied field. That is, that sample has better field emission properties, and the step S112 provided in the present invention can improve the field emission property of the film with respect to the prior art.

To sum up, the present invention mixes the diamond powders and the graphite fibers first, and then the abovementioned mixture is coated on the substrate as a nucleation layer. It is noted that the diamond powders will grow along the graphite fibers. The abovementioned nucleation process make the graphite distribute around the diamond grains to form a plurality of defects. Moreover, the conductivity will be raised due to the addition of the graphite fibers, and the work function of the materials will decrease due to the microstructure connected between the graphite fibers and the diamond powders for raising the conductivity and further improving its field emission efficiency. The turn-on field of the diamond-like carbon film can be reduced to be less than 5 V/μm. In the meantime the density and the distribution of the nucleation layer can be adjusted by adjusting the concentration and the mixed proportion of the mixing solution. Therefore, this idea can be applied to other substrate, and the diamond film will be applied extensively.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

I claim:

1. A diamond-like carbon film for improving an efficiency of a field emitting element being formed on a substrate and comprising a mixture of a graphite fiber and a diamond powder as its nucleation layer.

2. The diamond-like carbon film according to claim 1, wherein the diamond powder and the graphite fiber are mixed with a mixed proportion of 1:6.

3. The diamond-like carbon film according to claim 1, wherein the diamond powder and the graphite fiber are mixed with a mixed proportion of 2:5.

4. The diamond-like carbon film according to claim 1 has a turn-on field less than 5V/μm.

5. The diamond-like carbon film according to claim 1, wherein the nucleation layer comprises a first portion and a second portion covered thereon, wherein the first portion comprises the graphite fiber and the second portion comprises the diamond power and the graphite fiber.

6. The diamond-like carbon film according to claim 5, wherein the graphite fiber of the first portion is meshed and dispersed uniformly on the substrate.

7. The diamond-like carbon film according to claim 1, wherein the graphite fiber and the diamond power are both nanomaterials.

8. The diamond-like carbon film according to claim 1, wherein the nucleation layer is coated on the substrate by a spin coating process.

9. The diamond-like carbon film according to claim 1, wherein the substrate is a silicon substrate.

10. A method of fabricating a diamond-like carbon film, at least comprising the following steps:
providing a substrate;
providing a mixing solution composed of a graphite fiber and a diamond powder;
forming a nucleation layer on the substrate by utilizing the mixing solution; and
forming the diamond-like carbon film on the substrate by utilizing the nucleation layer.

11. The method according to claim 10, wherein the step of providing the mixing solution composed of the graphite fiber and the diamond powder further comprises the following steps:
mixing the diamond powder and the graphite fiber as a solute; and
adding an alcohol into the solute as a solvent to form the mixing solution.

12. The method according to claim 11, wherein the diamond powder and the graphite fiber are mixed with a mixed proportion of 1:6.

13. The method according to claim 11, wherein before the step of mixing the diamond powder and the graphite fiber as the solute, the method further comprises the following step:
acid washing the diamond powder.

14. The method according to claim 14, wherein the solute further comprises ethyl cellulose, and the diamond powder, the graphite fiber and the ethyl cellulose are mixed with a mixed proportion of 1:6:7.

15. The method according to claim 14, wherein the solute of the mixing solution has a total concentration of 0.045 g/ml.

16. The method according to claim 11, wherein the step of adding the alcohol into the solute as the solvent to form the mixing solution is performed inside a thick liquid mixer with an ultrasonic process.

17. The method according to claim 10, wherein the step of forming the nucleation layer on the substrate by utilizing the mixing solution is performed by a spin coating process.

18. The method according to claim 17, wherein the spin coating process has a rotational speed of 4500 rpm for 30 seconds.

19. The method according to claim 10, wherein after the step of forming the nucleation layer on the substrate by utilizing the mixing solution, the method further comprises the following step:
annealing the substrate.

20. The method according to claim 10, wherein the step of forming the diamond-like carbon film on the substrate by utilizing the nucleation layer is performed by microwave plasma enhanced chemical vapor deposition process.

21. The method according to claim 20, wherein the gas used in the microwave plasma enhanced chemical vapor deposition process is methane, hydrogen and argon.

22. The method according to claim 21, the methane, the hydrogen and the argon are mixed with a mixed proportion of 1:50:49.

23. The method according to claim 10, before the step of providing the substrate further comprising the following steps:
immersing the substrate in acetone; and
performing an ultrasonic process on the surface of the substrate.

24. The method according to claim 10, wherein the diamond-like carbon film fabricated thereof has a turn-on field less than 5V/μm.
